(19) United States
(12) Patent Application Publication
(10) Pub. No.: US 2018/0032818 A1
(43) Pub. Date: Feb. 1, 2018

(54) PROVIDING A PERSONALIZED FITTING ROOM EXPERIENCE

(71) Applicant: International Business Machines Corporation, Armonk, NY (US)

(72) Inventors: Subil M. Abraham, Lewisville, TX (US); Jason A. Gonzalez, Lewisville, TX (US); Biao Hao, Grapevine, TX (US)

(21) Appl. No.: 15/221,508

(22) Filed: Jul. 27, 2016

(51) Int. Cl. G06K 9/00; G06F 3/16; G06F 3/01; H04L 29/08; H04N 5/232

(52) U.S. Cl. CPC G06K 9/00771; H04L 67/306; H04N 5/23229; G06F 3/017; G06K 9/00362; G06F 3/167

(57) ABSTRACT

At least one image of a user can be captured. Responsive to the image being captured, a plurality of image parameters can be generated, the image parameters at least indicating a body shape of the user. Responsive to generating the image parameters, at least one garment style for the body shape of the user can be identified, based on the digital image analysis, by processing the image parameters. At least one garment that matches the garment style(s) can be selected. Responsive to identifying the at least one garment, a modified image depicting the user wearing the garment can be generated from the at least one image of the user and presented on a display.

### BACKGROUND

The present invention relates to systems that aid users with garment selections.

A fitting room is a room or area in a store where shoppers can put on clothes before buying them. In a fitting room a shopper can determine whether a garment fits. Moreover, many fitting rooms have mirrors. Thus, a shopper can put on a garment, and using the mirror, see how the garment looks on her. The availability of fitting rooms in a store is an important facet of providing a convenient garment shopping experience. Research has shown that shoppers who use fitting rooms are seventy percent more likely to purchase garments in comparison to shoppers who do not use fitting rooms.

### SUMMARY

A method includes capturing at least a first image of a user using at least one image capture device. The method also can include, responsive to capturing at least the first image of the user, generating a first plurality of image parameters by performing digital image analysis on at least the first image of the user, the first plurality of image parameters at least indicating a body shape of the user. The method also can include, responsive to generating the first plurality of image parameters, automatically identifying, based on the digital image analysis, at least a first garment style for the body shape of the user by processing the first plurality of image parameters. The method also can include, responsive to identifying at least the first garment style for the body shape of the user, automatically selecting at least a first garment that matches the first garment style. The method also can include, responsive to selecting at least the first garment that matches the first garment style, generating, using a processor, from at least the first image of the user a first modified image depicting the user wearing at least the first garment and presenting, on a display, the first modified image to the user.

A system includes a processor programmed to initiate executable operations. The executable operations include capturing at least a first image of a user using at least one image capture device. The executable operations also can include, responsive to capturing at least the first image of the user, generating a first plurality of image parameters by performing digital image analysis on at least the first image of the user, the first plurality of image parameters at least indicating a body shape of the user. The executable operations also can include, responsive to generating the first plurality of image parameters, automatically identifying, based on the digital image analysis, at least a first garment style for the body shape of the user by processing the first plurality of image parameters. The executable operations also can include, responsive to identifying at least the first garment style for the body shape of the user, automatically selecting at least a first garment that matches the first garment style. The executable operations also can include, responsive to selecting at least the first garment that matches the first garment style, generating from at least the first image of the user a first modified image depicting the user wearing at least the first garment and presenting, on a display, the first modified image to the user.

A computer program includes a computer readable storage medium having program code stored thereon. The program code is executable by a processor to perform a method. The method includes capturing at least a first image of a user using at least one image capture device. The method also can include, responsive to capturing at least the first image of the user, generating, by the processor, a first plurality of image parameters by performing digital image analysis on at least the first image of the user, the first plurality of image parameters at least indicating a body shape of the user. The method also can include, responsive to generating the first plurality of image parameters, automatically identifying, by the processor, based on the digital image analysis, at least a first garment style for the body shape of the user by processing the first plurality of image parameters. The method also can include, responsive to identifying at least the first garment style for the body shape of the user, automatically selecting, by the processor, at least a first garment that matches the first garment style. The method also can include, responsive to selecting at least the first garment that matches the first garment style, generating, by the processor, from at least the first image of the user a first modified image depicting the user wearing at least the first garment and presenting, on a display, the first modified image to the user.

### BRIEF DESCRIPTION OF THE DRAWINGS

FIG. 1 is a block diagram illustrating an example of a computing environment.

FIG. 2 is a block diagram illustrating example architecture for a processing system.

FIG. 3 is a flow chart illustrating an example of a method of presenting to a user an image depicting the user wearing a garment.

### DETAILED DESCRIPTION

This disclosure relates to systems that aid users with garment selections. In accordance with the arrangements described herein, a system can present to a user an image depicting the user wearing a garment the user has not worn. In illustration, while the user is in a fitting room, the system can capture one or more images of the user. For example, the system can record a 360° video of the user. Based on the captured images, the system can determine a body shape of the user, and automatically identify one or more garment styles for on the user's body shape, for example garment styles that are attractive on, or otherwise suitable for, the user's body shape. The system also can identify one or more garments that match the garment style(s). The system can generate, from at least one of the captured images, one or more modified images depicting the user wearing the identified garments and present the modified images to the user. Accordingly, the user can see how the garments will look on her without having to actually try on the garments. Further, the system can monitor gestures of the user when viewing the modified images to determine the user's sentiment toward the garments. The system can process the gesture data to guide additional garment selections. The system also can process user profile information to guide initial and/or additional garment selections.

Several definitions that apply throughout this document now will be presented.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

As defined herein, the term “user” means a person (i.e., a human being).

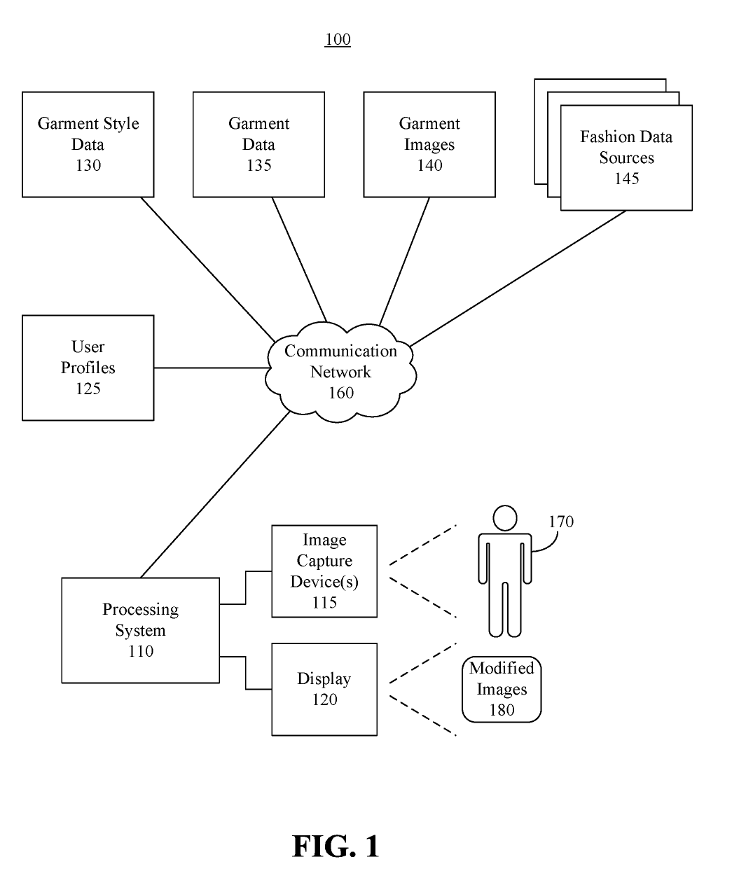

FIG. 1 is a block diagram illustrating an example of a computing environment 100.

The computing environment 100 can include at least one processing system 110 that includes at least one processor and memory. The processing system 110 can include, or can be communicatively linked to, one or more image capture devices 115. The image capture devices 115 can be, for example, cameras that capture still images and/or video. The processing system 110 also can include, or can be communicatively linked to, at least one display 120. In one non-limiting arrangement, the display 120 can be a touchscreen integrated into a mirror, for example a full length mirror. The full length mirror can have a width of at two feet and a height of at least five feet, and a top of the mirror can extend above a height of typical user's head. When the display 120 is inactive, the mirror can reflect light in a conventional manner, allowing users to view themselves in the mirror. When the display 120 is active (e.g., presenting one or more images), light generated by the display 120 can transmit through the mirror so that users see the image(s) in lieu of reflected light. Mirrors having integrated displays are known in the art. In one arrangement, an image capture device 115 also can be integrated into the mirror.

The computing environment 100 also can include user profiles 125, garment style data 130 and garment data 135. The user profiles 125, garment style data 130 and garment data 135 can be stored in one or more databases or other suitable data structures. Further, the computing environment 100 also can include garment images 140. The garment images 140 can be images of garments corresponding to the garment data 135 and can be categorized by the garment data 135. The databases (or other data structures) containing the garment style data 130 and garment data 135, as well as the garment images 140, can be stored to one or more computer readable storage mediums incorporated into, or otherwise communicatively linked to, one or more servers, each including at least one processor and memory. In this regard, the user profiles 125, garment style data 130, garment data 135 and garment images 140 are contained in functional data structures that impart functionality when employed by the processing system 110.

The computing environment 100 also can include fashion data sources 145 from which the processing system 110 can retrieve fashion data. Examples of the fashion data sources 145 include, but are not limited to, databases that collect fashion data, databases that collect garment purchases, systems that analyze fashion data, garment style trends, and garment purchasing trends, websites that provide fashion media, forums in which fashion is discussed, social networking systems, and so on.

The processing system 110 can be communicatively linked to various systems hosting the user profiles 125, garment style data 130, the garment data 135, the garment images 140 and the fashion data sources 145 via a communication network 160. The communication network 160 is the medium used to provide communications links between various devices and data processing systems connected together within the computing environment 100. The communication network 160 may include connections, such as wire, wireless communication links, or fiber optic cables. The communication network 160 can be implemented as, or include, any of a variety of different communication technologies such as a WAN, a LAN, a wireless network, a mobile network, a Virtual Private Network (VPN), the Internet, the Public Switched Telephone Network (PSTN), or similar technologies.

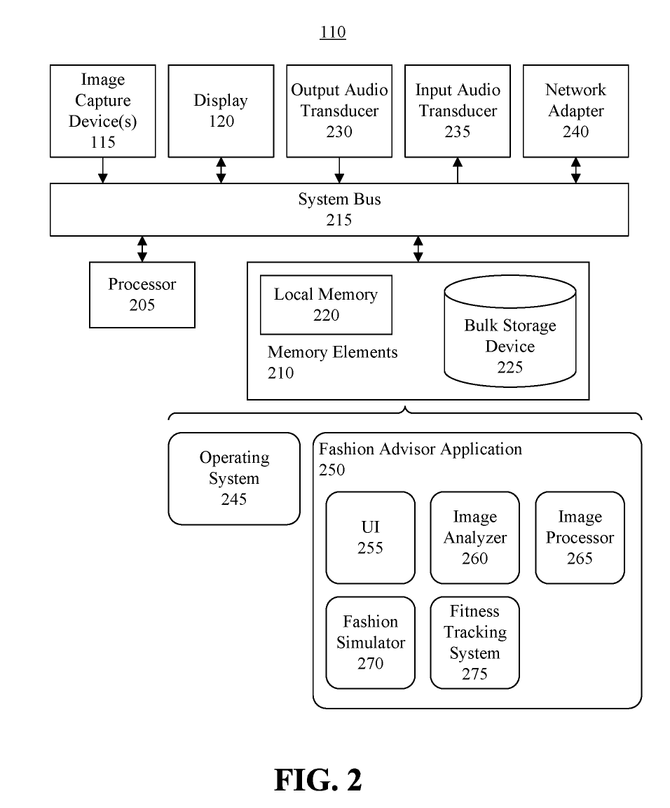

In operation, a user 170 can enter a fitting room, for example a fitting room within a retail outlet (e.g., store) that carries garments available for purchase. The processing system 110 can detect the user 170 entering the fitting room using the image capture device(s) 115, by detecting a door of the fitting room being locked, or detect presence of the user 170 in another suitable manner. Responsive to detecting the user 170 is present in the fitting room, the processing system 110 can prompt the user 170 to indicate that the processing system 110 is available to provide to the user 170 a personalized fitting room experience. The processing system 110 can prompt the user 170 by activating the display 120 and presenting on the display 120 an invitation to use the personalized fitting room experience, or by presenting an audible invitation via an output audio transducer (shown in FIG. 2), such as a loud speaker, with audible instructions on how to start the experience (e.g., “touch the mirror to begin your personalized fitting”). The user 170 can decline the invitation by selecting a menu item presented on the display (e.g., selecting a menu item on a touchscreen), in which case the display can enter an inactive mode and thus not be visible to the user 170, or by ignoring the audible instructions.

Responsive to the user 170 accepting the invitation, the processing system 110 can present, on the display 120, a user interface (shown in FIG. 2) prompting the user 170 to create a user profile 125 or enter a user identifier and password corresponding to an existing user profile 125 of the user 170. The processing system 110 also can prompt the user 170 to enter and/or update user profile 125 information for the user 170. The user 170 can, for example, enter an address, an e-mail address, a telephone number, a birthdate, an age, a height, a weight, demographic information, household income, and so on. The user 170 also can enter in the user profile 125 information regarding garment styles the user 170 prefers, for example, types of garments and/or garment features typically preferred by the user 170 (e.g., type of neckline, type of dress or skirt, pant type, shirt type, type of fit, preferred colors, etc.). The user also can enter in the user profile 125 information regarding price ranges the user expects to pay for various types of garments. Further, the user 170 can enter in the user profile 125 information relating to weight loss or weight gain goals, information relating to health/fitness goals, information related to physical activities and/or a level of exercise the user 170 performs or intends to perform, and so on. For example, the user 170 can enter information indicating that the user 170 plans to lose ten pounds over the next three months. The user also can enter in the user profile 125 information relating to a current or expected pregnancy, and clothing preferences for the pregnancy. Optionally, the user 170 can enter information relating to social networking systems in which the user 170 participates, as well as the user's user identifiers for the social networking systems.

In addition, the processing system 110 can present, via the user interface, various types of questions prompting the user 170 to select answers. For example, prior to selecting garment styles and garments/outfits for the user, the processing system can present to the user a plurality of images of models wearing different types of garments, and prompt the user 170 to select which outfit the user likes best. The processing system also can present other images and/or questions soliciting answers from the user 170, but such images and/or questions need not be directly related to fashion. Nonetheless, the processing system 110 can process the user's answers to determine a personality type of the user, determine garment styles the user tends to like, and do on. The processing system 110 can generate corresponding data and save the data to the user profile 125 of the user 170.

The user profiles 125 also can store information generated by one or more other systems. For example, the user profile 125 of the user 170 can include shopping history data indicating garments the user 170 previously purchased. The user profile 125 also can include data pertaining to garments the user has in a shopping cart (e.g., shopping cart of a website) and/or data pertaining to garments the user 170 has brought into the fitting room. Data pertaining to a website shopping cart can be obtained from the website, for example a website of the retail outlet. In this regard, the user profile 125 of the user 170 can be the same user profile the user 170 uses for online shopping with the retail outlet. Data pertaining to garments brought into the fitting room can be obtained from RFID tags attached to the garments. In this regard, the fitting room can be equipped with an RFID reader configured to read the RFID tags, and the RFID reader can be communicatively linked to the processing system 110.

At some time after the user 170 enters the fitting room, which may be before, after or during the collection of user profile information, the processing system 110 also can activate the image capture device(s) 115 to capture one or more images (e.g., video) of the user 170. For example, if a single image capture device 115 is provided, the processing system 110 can prompt the user 170 to stand in front of the image capture device 115 and turn 360°. If a plurality of image capture devices 115 are provided, the image capture devices 115 can be distributed around the fitting room so as to enable images of the front, back and each side of the user 170 to be captured. In one arrangement, the processing system 110 can prompt the user 170 to put on one or more of the garments the user 170 brought into the fitting room, and the images can be captured while the user 170 is wearing the garment(s).

Responsive to capturing the images of the user 170, the processing system 110 can generate a plurality of image parameters by performing digital image analysis on the images, for example using an image analyzer (shown in FIG. 2). Examples of digital image analysis techniques that may be used include, but are not limited to, three-dimensional recognition, image segmentation, feature extraction, and so on. At least a portion of the image parameters can indicate a body shape of the user 170. For example, the image parameters can indicate the user's height, approximate weight, approximate body mass index (BMI) size and contours of various portions of the user's body, etc. Other image parameters can indicate the user's hair style, hair color, a user's approximate age, etc.

Responsive to generating the image parameters, the processing system 110 can, in real time, automatically identify, based on the digital image analysis, one or more garment styles for the body shape of the user 170 by processing the first plurality of image parameters. For instance, garment styles that are attractive on, or otherwise suitable for, the body shape of the user 170 can be identified. In illustration, the processing system 110 can generate a query that includes as search parameters at least a portion of the image parameters, and use the query to retrieve indicators for garment styles that are attractive on the body shape of the user 170. For instance, the processing system 110 can communicate the query to the database containing the garment style data 130. The database can process the query to retrieve garment style data 130 corresponding to the image parameters. By way of example, the database can include a plurality of records, each record including an identifier for a particular garment style and image parameters that correspond to the garment style. A database application can match the image parameters contained in the query to image parameters contained in the records, and retrieve from those records having image parameters matching the query the identifiers for the corresponding garment styles. The image parameters contained in the records can be image parameters entered by database administrators, image parameters automatically determined by analyzing fashion data (e.g., fashion data provided by fashion data sources 145), and/or image parameters gathered in any other suitable manner. The database application can return to the processing system 110 results of the query, which can include identifiers indicating garment styles that are attractive on the body shape of the user 170.

In one arrangement, the query can retrieve identifiers for garment styles that not only are attractive on the body shape of the user 170, but also garment styles popular among people that are in a same age group as the user 170 and/or garment styles that will be popular at a future time. For example, the database record for each garment style can indicate an age group or age range for which the garment style is popular or for which the garment style is expected to be popular. In this regard, the query can include the image parameters indicating the user's approximate age and/or age parameters entered by the user 170 or otherwise indicated in the user's user profile 125. Similarly, the query can include image parameters indicating the user's hair style, and the garment style indicators retrieved from the database can indicate garments styles that are attractive on people having that hair style.

The query also can include user profile parameters, and retrieve identifiers for garment styles that not only are attractive on the body shape of the user 170, but also match the user profile parameters. In illustration, if the user's address indicates that the user 170 lives in a cold climate, the query can retrieve indicators of garment styles that are appropriate for a cold climate. If the user's profile parameters indicate the user is shopping for garments for a specific type of climate (e.g., warm weather or cold weather), the query can retrieve indicators of garment styles that are appropriate for the indicated type of climate. If the user's profile parameters indicate the user 170 is looking for garments that are formal attire, casual attire, business attire, beach attire or vacation attire, etc., the query can retrieve indicators of garment styles that fit the user's desired attire. Similarly, if the user's user profile 125 indicates that the user 170 prefers long skirts, the query can retrieve indicators of garment styles that include long skirts. If the user's user profile 125 indicates the user prefers garments within a certain price range, the query can retrieve indicators of garment styles that fall into that price range. If the user's user profile 125 indicates the user wears a certain hair style or has a certain hair color, the query can retrieve indicators of garment styles that look attractive with that hear style and/or hair color. Still, any other user profile parameters can be used in the selection of garment styles and the present arrangements are not limited in this regard.

Popularity, or expected future popularity, of garment styles can be based on garment style trends identified by processing data from the fashion data sources 145. In illustration, the processing system 110, or another suitable processing system, can monitor the fashion data sources 145 to identify fashion trends among a plurality of demographic groups. The processing system 110 (or other processing system) can generate garment style data 130 corresponding to the identified fashion trends and add that data to the database. In illustration, for a particular type of garment, the garment style data 130 can indicate that the garment style currently is popular among shoppers and/or fashion trend setters, that the popularity of that type of garment is increasing, or that the popularity of that type of garment is declining. In another example, the fashion data sources 145 can include fashion media (e.g., fashion publications, fashion blogs, web based forums related to fashion, etc.), and the garment style data 130 can indicate types of garments presented and/or discussed in the fashion publications. Further, the garment style data 130 can indicate types of garments being released by various garment designers.

To generate garment style data 130 from fashion data sources 145, the processing system 110 (or other processing system) can implement natural language processing (NLP) and semantic analysis on information contained in fashion media. NLP is a field of computer science, artificial intelligence and linguistics which implements computer processes to facilitate interactions between computer systems and human (natural) languages. NLP enables computers to derive computer-understandable meaning from natural language input. The International Organization for Standardization (ISO) publishes standards for NLP, one such standard being ISO/TC37/SC4. Semantic analysis is the implementation of computer processes to generate computer-understandable representations of natural language expressions. Semantic analysis can be used to construct meaning representations, semantic underspecification, anaphora resolution, presupposition projection and quantifier scope resolution, which are known in the art. Semantic analysis is frequently used with NLP to derive computer-understandable meaning from natural language input. An unstructured information management architecture (UIMA), which is an industry standard for content analytics, may be used by the processing system 110 to implement NLP and semantic analysis.

The processing system 110 (or other processing system) also can perform image recognition and processing on fashion images contained in or otherwise provided by the fashion data sources 145 to generate garment style data 130 from fashion data sources 145. For example, the processing system 110 can process fashion images to identify styles of garments contained in the fashion images. Image recognition and processing is known in the art. In one non-limiting arrangement, a cognitive system, such as IBM® Watson, to which the processing system 110 is communicatively linked can be used to process images, text and/or other data retrieved from the fashion data sources 145 to generate garment style data 130. Cognitive systems are known in the art, and are used to provide self learning by simulating human thought processes.

The processing system 110 (or other processing system) also can collect and analyze data from the fashion data sources 145 pertaining to shopping trends to generate garment style data 130 from fashion data sources 145. In illustration, one or more fashion data sources 145 can include data indicating sales volume for various types of garments in various geographic regions, data indicating how frequently shoppers try on various types of garments in fitting rooms in various geographic regions, etc. The processing system 110 can generate garment style data 130 from such data retrieved from the fashion data sources 145.

Responsive to identifying at least the first garment style for the body shape of the user 170, the processing system 110 can, in real time, automatically select at least one garment that matches the first garment style. In illustration, the processing system 110 can generate a query that includes as a search parameter an identifier for a garment style identified as being attractive on the body shape of the user 170. The processing system 110 can communicate the query to the database containing the garment data 135. A database application can process the query to retrieve identifiers for garments that fit the garment style identified for the user 170. The query also can include parameters corresponding to the data contained in the user's user profile 125, and the database application can use such parameters to select the garments. For example, if the user profile data indicates that the user prefers certain colors, such colors can be included in the query, and the database application can match garments that fit the garment style and that come in one or more of the preferred colors. The database application can return to the processing system 110 results of the query, which can include identifiers indicating the garments matching the query parameters.

In one arrangement, responsive to receiving the identifiers indicating the garments matching the query parameters, the processing system 110 can generate a query including those identifiers, and communicate the query to a database containing the garment images 140. In response to the query, a database application can communicate to the processing system 110 images for the garments matching the identifiers. In another arrangement, the database application providing the garment data 135 can access the garment images 140 and return the images to the processing system 110 with the query results provided by that database application.

Responsive to receiving the garment images 140, the processing system 110 can select one or more of the images captured of the user 170. For example, the processing system 110 can select a plurality of the images. The plurality of images can include an image of the front of the user 170, an image of the back of a user 170, and an image of a side of the user 170. The processing system 110 can generate from those images modified images 180 depicting the user 170 wearing a selected garment. In illustration, the processing system 110 can include an image processor (shown in FIG. 2) that perform image processing on the captured images of the user 170 to add to those images depictions of the garment parsed from the garment image 140 of the garment. In doing so, the processing system 110 can perform image processing on images of the garment to fit the images of the garment over the body of the user depicted in the images of the user. By way of example, if the garment is a form fitting dress, the processing system 110 can process the image of the dress to adjust contours of the dress to fit the user's body. Thus, the modified images 180 can depict the user 170 wearing the garment.

In one arrangement, the processing system 110 system can select a plurality of garments which together form an outfit, for example a blouse, skirt and belt, and the processing system 110 can depict in the modified image 180 the user wearing each of the garments together. The processing system 110 can determine which garments together form an outfit in any number of ways. For example, the garment data 135 can indicate garments that, together, form an outfit. In another example, the processing system 110, or a cognitive system to which the processing system 110 is communicatively linked, can be used to process images, text and/or other data retrieved from the fashion data sources 145 to generate outfit data indicating combinations of garments that are used to form outfits. For example, the outfit data can indicate that a particular style of blouse in a particular color is shown in fashion images as being used with a particular style of skirt in a particular color and a particular style of belt in a particular color. Still, there are numerous other combinations of garments that may be identified as forming outfits, and the present arrangements are not limited in this regard.

The above process can be repeated for a plurality of different garments/outfits. Thus, the processing system 110 system can generate a plurality of groups of modified images 180 depicting the user wearing a variety of selected garments/outfits that are attractive on the body shape of the user. As noted, the garments depicted also can correspond to preferences of the user 170 based on information received from the user 170.

The processing system 110 can present the modified images 180 on the display 120. The processing system 110 also can present a user interface with user selectable menu items, icons or controls configured to receive user inputs to navigate among the modified images 180. As noted, the display 120 can be incorporated into a full length mirror, and the modified images 180 can be presented to the user 170 in a manner in which the dimensions of the user 170 depicted in the modified images 180 are the user's actual dimensions. Thus, the processing system 110 can present to the user 170 a life size depiction of the user 170 wearing the selected garment(s). By way of example, a plurality of smaller modified images 180 can be presented along a top or side of the display, and responsive to the user selecting a modified image 180, the processing system 110 can enlarge the selected image to life size proportions. Moreover, the user 170 can select different modified images 180 depicting the user 170 wearing the same garment/outfit to view the user 170 wearing the garment/outfit from different angles (e.g., front, side and back). In one arrangement, the user interface can provide a control allowing the user to view modified images 180 of any angle, for example by allowing the user 170 to turn the depiction of the user 170 wearing the garment/outfit over a 360° range. In another arrangement, the fitting room can be equipped with an input audio transducer (shown in FIG. 2), such as a microphone, communicatively linked to the processing system 110 and configured to detect spoken utterances of the user 170. In such an arrangement, the user can turn the depiction of the user 170 wearing the garment/outfit over a 360° range by uttering voice commands (e.g., rotate left, rotate right, etc.) Nonetheless, the processing system 110 can, in real time, adjust a modified image 180 to accurately depict the user 170 from any desired angle using known image processing techniques.

The user interface provided by the processing system 110 can be highly interactive. For example, the user interface can present menu items and/or input fields that allow the user to specify and update various types of user information. For example, the user may be shopping for garments for different climates or weather conditions. Via the user interface, the user 170 can specify the climates and/or weather conditions, and the processing system 110 can select garment types and garments for the specified climates and/or weather conditions. The user also may be shopping for garments for different occasions. Via the user interface, the user 170 can specify casual attire, formal attire, business attire, beach or vacation attire, etc. and the processing system 110 can select garment types and garments that are the specified type of attire. Still, the user 170 can specify any of a myriad of information describing the type of garments the user is interested in, and the processing system 110 can process the information to select garments that match the information entered by the user, and present modified images 180 to the user 170 depicting the user wearing the selected garments.

In another example, the user 170 can enter information indicating a different hair color, hair style and/or age for the user 170. In response, the processing system 110 can adjust the modified image 180 to change the depiction of the user 170 to reflect the different hair color, hair style and/or age. For example, the processing system 110 can implement image processing to change the hair color, hair style and/or to change facial characteristics of the user 170 in accordance with facial aging algorithms. Such image processing is known in the art. Accordingly, the user 170 is able to see how the garment depicted in the modified image 180 will look on the user 170 for various hair colors, hair styles and/or ages of the user 170. Further, the processing system 110 can repeat the above garment style and garment selection processes to select additional garments that not only that are attractive on the body shape of the user 170, but also will be attractive with the new hair color and/or hair style and remain attractive on the user 170 as the user ages. Again, the processing system 110 can present to the user 170 modified images 180 depicting the user with the different hair color, hair style and/or age wearing the additionally selected garments.

In another example, the user 170 can enter information indicating that the user intends to lose or gain weight (e.g., a weight loss goal or a weight gain goal), and how much weight the user 170 intends to lose or gain. In response, the processing system 110 can repeat the above processes to select garment styles and garments for user's weight goal. Further, the processing system 110 can generate modified images 180 depicting the user 170 at the user's goal weight and wearing garments/outfits in sizes selected for the user 170 at that weight. The processing system 110 can implement a suitable image processing algorithm to adjust the dimensions and contours of the user's body, as well as the user's BMI, to accurately depict the user 170 at the desired weight. Such image processing algorithms are known in the art.

In one arrangement, the processing system 110 can indicate to the user 170 the size of a garment presented in the modified image 180. Via the user interface, the user can select a different size, and the processing system can adjust the modified image 180 to depict the user wearing the garment in the different size. Further, the processing system 110 can present a menu item which the user may select to cause the processing system 110 to adjust, in the modified image 180, the user's body dimensions and contours to a point where the different size fits the user 170. Moreover, the processing system 110 can determine, based on the projected body adjustments, an amount of weight the user 170 would need to lose for the different size to properly fit the user 170. This can provide encouragement for the user 170 to lose weight. Moreover, the processing system 110 can provide recommendations for losing weight, for example exercises the user 170 may consider performing and dietary suggestions. Further, the processing system 110 can prompt the user 170 to indicate a time frame for losing the weight, and provide the recommendations to achieve the weight loss goal within that time frame (e.g., amount of daily caloric input and a daily exercise regimen).

A gamification strategy can be used to encourage weight loss. In illustration, the processing system 110 can present to the user 170 offers or incentives for the user 170 to achieve certain fitness and lifestyle goals. For instance, the processing system 110 can offer discounts on purchases and/or customer loyalty points. The processing system 110 can track the user's progress in any number of ways. For example, the processing system 110 can prompt the user 170 to participate in a fitness/lifestyle tracking process. If the user chooses to do so, the processing system 110 can periodically communicate to the user a prompt to visit the retail outlet and enter a fitting room for additional interaction with the processing system 110. The processing system 110 can communicate the prompts via e-mail, text messaging, postal mail, etc. This can serve to bring the user 170 back to the store, which may encourage the user to shop while there. While in the fitting room, the processing system 110 can again capture images of the user 170 and perform image processing on the captured images to determine the user's current weight, BMI, etc. The processing system 110 can compare this data to previous data of the user 170, which can be contained in the user profile 125 of the user, to determine whether the user is on track to achieve the fitness and lifestyle goals.

In another example the processing system 110 can periodically prompt the user 170 to communicate recent images captured of the user to the processing system 110, for example via e-mail, text messaging or file upload, and the processing system 110 can process the images to determine the user's current weight, BMI, etc. Again, the processing system 110 can compare this data to previous data of the user 170 to determine whether the user is on track to achieve the fitness and lifestyle goals. In yet another example, the processing system 110 can periodically prompt the user 170 to log into a website and enter the user's current weight, and the processing system can compare the current weight to previous weights of the user 170 contained in the user profile.

Regardless of how the determination is made as to whether the user is on track to achieve the fitness and lifestyle goals, responsive to the goals being met, the processing system 110 can initiate reward of the offers or incentives to the user 170. For example, the processing system 110 can e-mail or text message the offers or incentives to the user 170, initiate postal mailing of the offers or incentives, or update the user profile 125 of the user 170 to include the offers or incentives.

Returning to the interaction of the user 170 with the processing system 110 while the user is in the fitting room, via the user interface or output audio transducer, the processing system 110 also can present to the user information regarding fashion trends and how this information relates to the selected garment styles and/or garments/outfits. In illustration, when presenting a particular modified image 180 on the display 120, the processing system 110 also can present information indicating how the garment/outfit depicted in the modified image 180 relates to fashion trends. For example, the processing system 110 can present text on the display 120 (e.g., above, next to or over the modified image 180) indicating whether the garment style of the garment currently is popular, whether the garment style is gaining in popularity, whether the garment style is declining in popularity, whether the garment style is expected to be a fashion trend at some future time, etc. Such information can help the user 170 in garment purchasing decisions. For example, if the user 170 desires to be a fashion trend setter, the user 170 may be inclined to purchase garments that have a garment style that is not yet popular, but is expected to grow in popularity. On the other hand, if the user 170 does not desire to be a fashion trend setter, the user may be inclined to purchase garments that currently are popular.

The processing system 110 also can continuously capture images of the user 170 responsive to modified images 180 being presented to the user 170 and/or responsive to the user 170 trying on garments. The processing system 110 can perform image processing and gesture recognition, which is known to the skilled artisan, on such captured images to identify gestures made by the user 170 while viewing the modified images 180 or trying on garments. In the case that the user is trying on garments, the processing system 110 identify the garments being put on based on the image processing. The gestures can be, for example, facial gestures, body gestures (e.g., body orientation or movement, hand/arm orientation or movement, etc.) and/or spoken gestures. Based on the gestures made by the user 170 while viewing the modified images 180, the processing system 110 can infer the user's sentiment toward various modified images 180, and thus infer the user's sentiment to the garments/outfits presented in the modified images 180. Further, based on the gestures made by the user 170 while trying on a garment, the processing system 110 can infer the user's sentiment toward the garment. For example, if the user 170 frowns while trying on a garment or viewing a modified image 180 depicting the user 170 wearing the garment, the processing system 110 can infer that the user 170 does not like the garment. If the user 170 smiles while trying on a garment or viewing a modified image 180 depicting the user 170 wearing a garment, the processing system 110 can infer that the user 170 likes the garment.

The processing system 110 also can continuously monitor audible sounds (speech and other sounds) uttered by the user 170, for example via the microphone, responsive to presenting modified images 180 to the user 170 and/or responsive to the user 170 trying on garments. Responsive to detecting the audible sounds, the processing system 110 can perform audio processing on the audible sounds to identify vocal gestures of the user and, based on the vocal gestures, infer the user's sentiment toward a garment being tried on or depicted in the modified images 180. For example, the user may utter “No, I don't like that,” “Awful,” or “Ugh,” which the processing system can process to infer that the user 170 does not like the garment. On the other hand, the user may utter “I like that” or “nice,” which the processing system can process to infer that the user 170 likes the garment.

The processing system 110 also may present on the display 120, with the modified images 180, user input fields, buttons or icons which the user 170 can select to indicate whether the user 170 likes, dislikes or is indifferent to the garment/outfit. In another aspect, the processing system 110 can prompt the user to indicate such via the output audio transducer. In one arrangement, the processing system 110 can prompt the user 170 to rate each garment/outfit on a scale, for example from 1 to 5. Still, user's sentiment toward a particular garment/outfit can be inferred from other user gestures and the present arrangements are not limited in this regard.

The processing system 110 can store to the user profile 125 of the user 170 sentiment data corresponding to the user's sentiment toward the garments/outfits as determined by the inferences. The processing system 110 also can process the sentiment data to update the user's preferences in the user profile 125 of the user 170. Further, the processing system 110 can process, in real time as the inferences are made, the sentiment data to determine types of garments that are pleasing to the user 170 and types of garments that are not pleasing to the user 170. For example, if the user provides a positive sentiment toward a red skirt, the user's preferences can be updated to indicate that the color red is a color the user 170 may have interest and that the user 170 may have interest in skirts. In this regard, the processing system 110 can learn the user's fashion tastes based on the gestures made by the user 170 while viewing the modified images 180. In one arrangement, the processing system 110 can interface, in real time, with a cognitive system that processes the sentiment data, and the cognitive system can learn the user's fashion tastes and communicate data corresponding to such learning to the processing system 110.

Based on the learned fashion tastes of the user 170, the processing system 110 can again perform the above described garment style and garment selection processes to select additional garments/outfits for the user 170. The processing system 110 also can generate additional modified images 180 depicting the user 170 wearing those garments/outfits and present the additional modified images 180 to the user 170, for example as previously described. For instance, if the user reacted positively toward a red skirt, the processing system 110 can select other skirts and other garments that are red, and present modified images 180 to the user 170 depicting the user wearing those garments. Again, the user's sentiments can be determined and learning of the user's fashion tastes can continue throughout the user session of the user 170 interacting with the processing system 110.

Since the sentiment data generated during the user session is stored to the user profile 125 of the user 170, the processing system 110 can use the sentiment data during future user sessions to guide selection of garment styles and garments/outfits for the user. For example, when generating queries to select garment styles and garments, the processing system 110 can include in the queries parameters corresponding to fashion styles the user likes. Further, the processing system select parameters that mitigate selection of fashion styles the user does not like. Thus, the processing system can repeatedly learn the user's fashion tastes and improve recommendations of garments/outfits to the user 170. It should be noted, however, that the user's fashion tastes may evolve over time. Accordingly, the processing system 110 can provide greater weight to more recent data and less weight to older data when selecting garment styles and garments. Moreover, the processing system 110 can periodically present to the user 170 modified images 180 of the user 170 wearing garments the user is not expected to like, but the user's sentiment to such modified images 180 can be processed to identify changes in the user's fashion tastes.

FIG. 2 is a block diagram illustrating example architecture for the processing system 110 of FIG. 1 configured in accordance with an arrangement disclosed within this specification. The processing system 110 can include at least one processor 205 (e.g., a central processing unit) coupled to memory elements 210 through a system bus 215 or other suitable circuitry. As such, the processing system 110 can store program code within the memory elements 210. The processor 205 can execute the program code accessed from the memory elements 210 via the system bus 215. It should be appreciated that the processing system 110 can be implemented in the form of any system including a processor and memory that is capable of performing the functions and/or operations described within this specification. For example, the processing system 110 can be implemented as a server, a plurality of communicatively linked servers, a workstation, a desktop computer, a mobile computer, a tablet computer, a laptop computer, a netbook computer, a network appliance, and so on.

The memory elements 210 can include one or more physical memory devices such as, for example, local memory 220 and one or more bulk storage devices 225. Local memory 220 refers to random access memory (RAM) or other non-persistent memory device(s) generally used during actual execution of the program code. The bulk storage device(s) 225 can be implemented as a hard disk drive (HDD), solid state drive (SSD), or other persistent data storage device. The processing system 110 also can include one or more cache memories (not shown) that provide temporary storage of at least some program code in order to reduce the number of times program code must be retrieved from the bulk storage device 225 during execution.

Input/output (I/O) devices such as the image capture device(s) 115, the display (e.g., touchscreen) 120, an output audio transducer (e.g., a speaker) 230 and an input audio transducer (e.g., microphone) 235 can be coupled to the processing system 110. The I/O devices can be coupled to the processing system 110 either directly or through intervening I/O controllers. For example, the display 120 can be coupled to the processing system 110 via a graphics processing unit (GPU), which may be a component of the processor 205 or a discrete device. One or more network adapters 240 also can be coupled to processing system 110 to enable the processing system 110 to become coupled to other systems, computer systems, remote printers, and/or remote storage devices through intervening private or public networks. Modems, cable modems, transceivers, and Ethernet cards are examples of different types of network adapters 240 that can be used with the processing system 110.

As pictured in FIG. 2, the memory elements 210 can store the components of the processing system 110, namely an operating system 245 and a fashion advisor application 250. Being implemented in the form of executable program code, these components of the processing system 110 can be executed by the processing system 110 and, as such, can be considered part of the processing system 110. Moreover, the operating system 245 and the fashion advisor application 250 are functional data structures that impart functionality when employed as part of the processing system 110.

The fashion advisor application 250 can include a user interface 255, an image analyzer 260, an image processor 265, a fashion simulator 270 and a fitness tracking system 275. The fashion advisor application 250 also can include various other components, and the present arrangements are not limited in this regard. The user interface 255 can present images, modified images, menus, icons, buttons, controls, etc. on the display 120, receive user inputs received the display 120 (e.g., touchscreen), generate audio signals output by the output audio transducer 230 and receive audio signals detected by the input audio transducer 235. The user interface 255 can communicate received inputs and signals to other components of the fashion advisor application 250. The image analyzer 260 can perform digital image analysis on images captured by the image capture device(s) 115 to generate image parameters as described herein. The image processor 265 can perform image processing on captured images to generate modified images as described herein. The image processor 265 also can perform image processing on captured images or modified images to change depictions of users (e.g., weight, BMI, hair color, hair style, age features, etc.) and fit depicted garments to the depictions of users as described herein. The fashion simulator 270 can select garments to depict as being worn by users in the modified images, provide fashion recommendations to users, etc. as described herein. The fitness tracking system 275 can track user fitness, provide fitness/lifestyle offers/incentives, and initiate fitness/lifestyle and offer/incentive related communications to users as described herein.

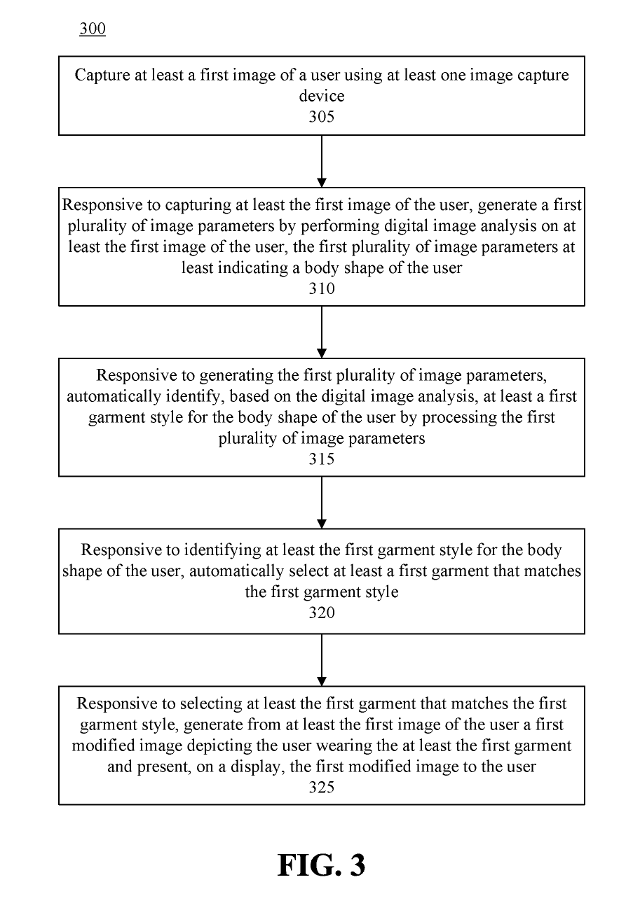

FIG. 3 is a flow chart illustrating an example of a method 300 of presenting to a user an image depicting the user wearing a garment. At step 305, at least a first image of a user can be captured using at least one image capture device. At step 310, responsive to capturing at least the first image of the user, a processing system can generate a first plurality of image parameters by performing digital image analysis on at least the first image of the user, the first plurality of image parameters at least indicating a body shape of the user. For example, the processing system can execute an image analyzer to generate the first plurality of image parameters. At step 315, responsive to generating the first plurality of image parameters, the processing system can automatically identify, based on the digital image analysis, at least a first garment style for the body shape of the user by processing the first plurality of image parameters. At step 320, responsive to identifying at least the first garment style for the body shape of the user, the processing system can automatically select at least a first garment that matches the first garment style. For example, the processing system can execute a fashion simulator to select at least the first garment. At step 325, responsive to selecting at least the first garment that matches the first garment style, the processing system can generate from at least the first image of the user a first modified image depicting the user wearing the at least the first garment and present, on a display, the first modified image to the user. For example, the processing system can execute an image processor to generate the first modified image.

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
capturing at least a first image of a user using at least one image capture device;
responsive to capturing at least the first image of the user, generating a first plurality of image parameters by performing digital image analysis on at least the first image of the user, the first plurality of image parameters at least indicating a body shape of the user;
responsive to generating the first plurality of image parameters, automatically identifying, based on the digital image analysis, at least a first garment style for the body shape of the user by processing the first plurality of image parameters;
responsive to identifying at least the first garment style for the body shape of the user, automatically selecting at least a first garment that matches the first garment style; and
responsive to selecting at least the first garment that matches the first garment style, generating, using a processor, from at least the first image of the user a first modified image depicting the user wearing at least the first garment and presenting, on a display, the first modified image to the user.

2. The method of claim 1, further comprising:
receiving, from the user, user profile information;
wherein automatically identifying at least the first garment style for the body shape of the user is based, at least in part, on the user profile information.

3. The method of claim 1, further comprising:
tracking garment style trends and, based on the garment style trends, determining a plurality of garment styles anticipated to be popular at a future time;
receiving, from the user, user profile information;
based, at least on the image parameters and the user profile information, identifying at least a second garment style for the body shape of the user, the second garment style selected from the plurality of garment styles anticipated to be popular at the future time;
responsive to identifying at least the second garment style for the body shape of the user, automatically identifying at least a second garment that matches the second garment style; and
responsive to identifying at least the second garment that matches the second garment style, generating from at least the first image of the user a second modified image depicting the user wearing at least the second garment and presenting, on the display, the second modified image to the user.

4. The method of claim 1, further comprising:
responsive to presenting, on the display, the first modified image to the user, capturing at least a second image of a user using the image capture device;
responsive to capturing at least the second image of the user, generating a second plurality of image parameters by performing digital image analysis on at least the second image of the user, the second plurality of image parameters at least indicating a user gesture provided by the user;
responsive to generating the second plurality of image parameters, automatically identifying the user gesture by processing the second plurality of image parameters;
responsive to automatically identifying the user gesture, determining a sentiment of the user for at least the first garment;
based on the sentiment of the user for at least the first garment, automatically selecting at least a second garment; and
responsive to identifying at least the second garment, generating from at least the first image of the user a second modified image depicting the user wearing the at least the second garment and presenting, on the display, the second modified image to the user.

5. The method of claim 1, further comprising:
responsive to presenting, on the display, the first modified image to the user, monitoring audible sounds uttered by the user;
responsive to detecting at least one audible sound uttered by the user, identifying at least one vocal gesture of the user by performing audio processing on the audible sound;
responsive to automatically identifying the vocal gesture, determining a sentiment of the user for at least the first garment;
based on the sentiment of the user for at least the first garment, automatically selecting at least a second garment; and
responsive to identifying at least the second garment, generating from at least the first image of the user a second modified image depicting the user wearing the at least the second garment and presenting, on the display, the second modified image to the user.

6. The method of claim 1, further comprising:
receiving, from the user, a user input indicating a weight loss goal or a weight gain goal;
responsive to receiving, from the user input indicating the weight loss goal or the weight gain goal, automatically identifying at least a second garment that is selected for the user at a goal weight; and
responsive to automatically identifying at least the second garment that is selected for the user at the goal weight, generating from at least the first image of the user a second modified image depicting the user at the goal weight wearing at least the second garment and presenting, on the display, the second modified image to the user.

7. The method of claim 1, wherein the display is a component of a mirror in a fitting room.

8. A system, comprising:
a processor programmed to initiate executable operations comprising:
capturing at least a first image of a user using at least one image capture device;
responsive to capturing at least the first image of the user, generating a first plurality of image parameters by performing digital image analysis on at least the first image of the user, the first plurality of image parameters at least indicating a body shape of the user;
responsive to generating the first plurality of image parameters, automatically identifying, based on the digital image analysis, at least a first garment style for the body shape of the user by processing the first plurality of image parameters;
responsive to identifying at least the first garment style for the body shape of the user, automatically selecting at least a first garment that matches the first garment style; and
responsive to selecting at least the first garment that matches the first garment style, generating from at least the first image of the user a first modified image depicting the user wearing at least the first garment and presenting, on a display, the first modified image to the user.

9. The system of claim 8, the executable operations further comprising:
receiving, from the user, user profile information;
wherein automatically identifying at least the first garment style for the body shape of the user is based, at least in part, on the user profile information.

10. The system of claim 8, the executable operations further comprising:
tracking garment style trends and, based on the garment style trends, determining a plurality of garment styles anticipated to be popular at a future time;
receiving, from the user, user profile information;
based, at least on the image parameters and the user profile information, identifying at least a second garment style for the body shape of the user, the second garment style selected from the plurality of garment styles anticipated to be popular at the future time;
responsive to identifying at least the second garment style for the body shape of the user, automatically identifying at least a second garment that matches the second garment style; and
responsive to identifying at least the second garment that matches the second garment style, generating, from at least the first image of the user, a second modified image depicting the user wearing at least the second garment and presenting, on the display, the second modified image to the user.

11. The system of claim 8, the executable operations further comprising:
responsive to presenting, on the display, the first modified image to the user, capturing at least a second image of a user using the image capture device;
responsive to capturing at least the second image of the user, generating a second plurality of image parameters by performing digital image analysis on at least the second image of the user, the second plurality of image parameters at least indicating a user gesture provided by the user;
responsive to generating the second plurality of image parameters, automatically identifying the user gesture by processing the second plurality of image parameters;
responsive to automatically identifying the user gesture, determining a sentiment of the user for at least the first garment;
based on the sentiment of the user for at least the first garment, automatically selecting at least a second garment; and
responsive to identifying at least the second garment, generating from at least the first image of the user a second modified image depicting the user wearing the at least the second garment and presenting, on the display, the second modified image to the user.

12. The system of claim 8, the executable operations further comprising:
responsive to presenting, on the display, the first modified image to the user, monitoring audible sounds uttered by the user;
responsive to detecting at least one audible sound uttered by the user, identifying at least one vocal gesture of the user by performing audio processing on the audible sound;
responsive to automatically identifying the vocal gesture, determining a sentiment of the user for at least the first garment;
based on the sentiment of the user for at least the first garment, automatically selecting at least a second garment; and
responsive to identifying at least the second garment, generating from at least the first image of the user a second modified image depicting the user wearing the at least the second garment and presenting, on the display, the second modified image to the user.

13. The system of claim 8, the executable operations further comprising:
receiving, from the user, a user input indicating a weight loss goal or a weight gain goal;
responsive to receiving, from the user input indicating the weight loss goal or the weight gain goal, automatically identifying at least a second garment that is selected for the user at a goal weight; and
responsive to automatically identifying at least the second garment that is selected for the user at the goal weight, generating from at least the first image of the user a second modified image depicting the user at the goal weight wearing at least the second garment and presenting, on the display, the second modified image to the user.

14. The system of claim 8, wherein the display is a component of a mirror in a fitting room.

15. A computer program product comprising a computer readable storage medium having program code stored thereon, the program code executable by a processor to perform a method comprising:
capturing at least a first image of a user using at least one image capture device;
responsive to capturing at least the first image of the user, generating, by the processor, a first plurality of image parameters by performing digital image analysis on at least the first image of the user, the first plurality of image parameters at least indicating a body shape of the user;
responsive to generating the first plurality of image parameters, automatically identifying, by the processor, based on the digital image analysis, at least a first garment style for the body shape of the user by processing the first plurality of image parameters;
responsive to identifying at least the first garment style for the body shape of the user, automatically selecting, by the processor, at least a first garment that matches the first garment style; and
responsive to selecting at least the first garment that matches the first garment style, generating, by the processor, from at least the first image of the user a first modified image depicting the user wearing at least the first garment and presenting, on a display, the first modified image to the user.

16. The computer program product of claim 15, the method further comprising:
receiving, from the user, user profile information;
wherein automatically identifying at least the first garment style for the body shape of the user is based, at least in part, on the user profile information.

17. The computer program product of claim 15, the method further comprising:
tracking garment style trends and, based on the garment style trends, determining a plurality of garment styles anticipated to be popular at a future time;
receiving, from the user, user profile information;
based, at least on the image parameters and the user profile information, identifying at least a second garment style for the body shape of the user, the second garment style selected from the plurality of garment styles anticipated to be popular at the future time;
responsive to identifying at least the second garment style for the body shape of the user, automatically identifying at least a second garment that matches the second garment style; and
responsive to identifying at least the second garment that matches the second garment style, generating from at least the first image of the user a second modified image depicting the user wearing at least the second garment and presenting, on the display, the second modified image to the user.

18. The computer program product of claim 15, the method further comprising:
responsive to presenting, on the display, the first modified image to the user, capturing at least a second image of a user using the image capture device;
responsive to capturing at least the second image of the user, generating a second plurality of image parameters by performing digital image analysis on at least the second image of the user, the second plurality of image parameters at least indicating a user gesture provided by the user;
responsive to generating the second plurality of image parameters, automatically identifying the user gesture by processing the second plurality of image parameters;
responsive to automatically identifying the user gesture, determining a sentiment of the user for at least the first garment;
based on the sentiment of the user for at least the first garment, automatically selecting at least a second garment; and
responsive to identifying at least the second garment, generating from at least the first image of the user a second modified image depicting the user wearing the at least the second garment and presenting, on the display, the second modified image to the user.

19. The computer program product of claim 15, the method further comprising:
responsive to presenting, on the display, the first modified image to the user, monitoring audible sounds uttered by the user;
responsive to detecting at least one audible sound uttered by the user, identifying at least one vocal gesture of the user by performing audio processing on the audible sound;
responsive to automatically identifying the vocal gesture, determining a sentiment of the user for at least the first garment;
based on the sentiment of the user for at least the first garment, automatically selecting at least a second garment; and
responsive to identifying at least the second garment, generating from at least the first image of the user a second modified image depicting the user wearing the at least the second garment and presenting, on the display, the second modified image to the user.

20. The computer program product of claim 15, the method further comprising:
receiving, from the user, a user input indicating a weight loss goal or a weight gain goal;
responsive to receiving, from the user input indicating the weight loss goal or the weight gain goal, automatically identifying at least a second garment that is selected for the user at a goal weight; and
responsive to automatically identifying at least the second garment that is selected for the user at the goal weight, generating from at least the first image of the user a second modified image depicting the user at the goal weight wearing at least the second garment and presenting, on the display, the second modified image to the user.
